(19) United States
(12) Patent Application Publication
(10) Pub. No.: US 2026/0360131 A1
(43) Pub. Date: Nov. 12, 2026

(54) ASSESSMENT OF THE PERFORMANCE OF AN OBJECT DETECTION SYSTEM FOR VEHICLES AND ROBOTS

(71) Applicant: Robert Bosch GmbH, Stuttgart (DE)

(72) Inventors: Maria Lyssenko, Stuttgart (DE); Oliver Lange, Hemmingen (DE)

(21) Appl. No.: 19/265,270

(22) Filed: Jul. 10, 2025

(30) Foreign Application Priority Data
Jul. 22, 2024 (DE) 10 2024 206 881.0

(51) Int. Cl. G06V 10/776; G01S 13/86; G06V 10/82; G06V 20/58

(52) U.S. Cl. CPC G06V 10/776; G01S 13/867; G06V 10/82; G06V 20/58

(57) ABSTRACT

A method for assessing the performance of an object detection system that monitors the surrounding area for the presence and/or occurrence of objects based on measurement data. In the method: an object instance recognized by evaluating the measurement data is identified as an object that has been recognized as a false positive and does not correspond to any object actually present in the surrounding area of the vehicle and/or robot; for the object recognized as a false positive, a criticality assessment is ascertained, which is based on the extent to which the object that has been recognized as a false positive would be relevant for planning the future behavior of a vehicle or robot if the object actually existed; the desired performance of the object detection system is ascertained based on criticality assessments of one or more objects that have been recognized as a false positive.

### FIELD

The present invention relates to object detection systems that are used in the environmental monitoring of vehicles and/or robots and can be used in particular for at least partially automated guidance of the vehicle or robot.

### BACKGROUND INFORMATION

Driving a vehicle or operating a robot on company premises or even in public traffic requires constant monitoring of the environment of the vehicle or robot. The planning of the future behavior of the vehicle or robot depends in particular on which objects are in the particular environment. Therefore, measurement data that relate to an observation of the environment with one or more sensors are evaluated using an object detection system that recognizes object instances.

During training and testing of such object detection systems, prior knowledge of the respectively observed scenes is used to check whether all objects that are present in the scene according to such prior knowledge (“ground truth”) are completely and correctly recognized. This ensures that the presence of each object triggers the required response.

### SUMMARY

The present invention provides a method for assessing the performance of an object detection system. The object detection system monitors the surrounding area of a vehicle and/or robot for the presence and/or occurrence of objects on the basis of measurement data obtained by observing this surrounding area with at least one sensor. The measurement data can comprise, for example, camera images, video images, thermal images, radar data, lidar data, ultrasound data or any combination of these measurement modalities. In particular, the object detection system can, for example, recognize individual object instances and, for this purpose, ascertain any desired attributes, such as a position, a velocity vector, a type or a spatial extent, for example in the form of a “bounding box” that encloses the object.

Within the scope of the method according to an example embodiment of the present invention, at least one object instance recognized by evaluating the measurement data using the object detection system is identified as an object that has been recognized as a false positive and does not correspond to any object actually present in the surrounding area of the vehicle and/or robot. This recognition can be carried out in any suitable manner. In particular, for example, at least one recognized object instance can be identified as an object that has been recognized as a false positive by comparing it with objects that are actually present in the surrounding area of the vehicle and/or robot in the situation embodied by the measurement data, as evidenced by prior knowledge. For example, if, as evidenced by this prior knowledge, a certain set of target object instances are expected to be present, and a recognized object instance does not correspond to any of these target object instances, it is likely that this object instance was falsely recognized as a positive.

False-positive object instances can be identified alternatively or in combination, for example, from the combination of a plurality of measurement modalities and/or measurements taken from different perspectives. For example, if an object protruding from the road has been recognized at a certain location, but at the same time reliable depth information for this location indicates that there is only a flat road surface there, then it is clear that this is an object that has been recognized as a false positive. The same applies if, for example, camera images from a different perspective contradict the presence of the purportedly recognized object. For example, if a bus has been recognized as an object instance, but at the same time a camera has a clear view through this bus to the road surface, the bus cannot actually be present at the location where it was purportedly recognized. The basic physical prior knowledge that a bus is not transparent can thus be used to expose an object instance recognized as a false positive. In a similar way, conformity with other physical laws can be used to check whether a recognized object instance can actually physically exist. For example, a normal land vehicle cannot float freely in the air, and a truck cannot stand on top of a car.

According to an example embodiment of the present invention, a criticality assessment is ascertained for the object that has been recognized as a false positive. This criticality assessment is based, at least in part, on the extent to which the object that has been recognized as a false positive would be relevant for planning the future behavior of the vehicle or robot if it actually existed. For example, a pedestrian that has been recognized as a false positive in front of the vehicle or robot in the direction of travel is to be assessed as highly critical, because if this pedestrian were actually present, the vehicle or robot would have to brake or swerve immediately to avoid a collision. However, if the pedestrian is not actually present, such a maneuver comes as a complete surprise to other road users and can, for example, lead to rear-end collisions. The occupants of the vehicle that suddenly brakes or swerves can also be injured, in particular if it is a bus, train or other means of public transport in which experience shows that not all passengers always make sure they hold on securely as required.

However, if a pedestrian is recognized in the sky or at a safe distance from the road, this is not critical, because the vehicle or robot could not collide with a pedestrian actually present at that location.

The desired performance of the object detection system is ascertained, at least in part, on the basis of criticality assessments of one or more objects that have been recognized as a false positive. In particular, this may mean, for example, that objects that have been recognized as a false positive in the performance assessment lead to a penalty depending on their particular criticality assessment.

It has been recognized that the use of objects that have been recognized as a false positive, in particular in combination with the criticality assessment of each individual object that has been recognized as a false positive, leads to a more meaningful assessment of the performance of the object detection system. Many of these systems are optimized primarily to avoid false-negative omissions of a recognition, so that the vehicle or robot does not fail to respond to an object that is actually present under any circumstances. The flip side of this coin is that the susceptibility to false-positive recognitions is increased. The systems recognize object instances with a very low threshold, preferring to recognize one object instance too many rather than one too few. If all objects that have been recognized as a false positive were included in the assessment of the performance of the object detection system without taking their particular criticality into account, the low-threshold recognition of objects would be penalized far too severely, so that more false-negative omissions would arise. The criticality assessment ensures that only the objects that have been recognized as a false positive and are actually disruptive are “penalized.” In a particularly advantageous example embodiment of the present invention, in response to the fact that the vehicle or robot can reach locations within a specified forecast horizon that the object that has been recognized as a false positive could also reach if it actually existed, the object that has been recognized as a false positive is assessed as relevant for planning the future behavior of the vehicle or robot. Thus, the hypothesis is that the object actually exists, and based on this hypothetical situation, an assessment is made by comparing, in each case, reachable locations to determine whether a collision could occur between the vehicle or robot on the one hand and the object on the other hand. If this is not the case, there is no reason as to why the vehicle or robot should modify its future behavior due to the presence of the object.

In this check, for example, a type of object that has been recognized as a false positive is ascertained by the object detection system and/or by an object classifier connected downstream of the object detection system and can be used for ascertaining the locations that this object could reach. For example, a pedestrian can only move in a much smaller area in a given time than a car, and a car has a much smaller spatial extent than a truck, so it occupies slightly less space at any given time. However, the reachable sets of locations are roughly the same for a car and a truck, since they can be derived, for example, from the current speed and possible acceleration.

The check as to which locations can be reached by an object, vehicle or robot can be carried out, for example, on the basis of any suitable physical movement model for the object, vehicle or robot. In order to take into account the uncertainty of future movement, movement models based on differential inclusions can be used. Such movement models, with appropriate parameterization, provide a reliable upper estimate of all locations that the object, vehicle or robot can reach within a certain time horizon. Differential inclusions are generalizations of ordinary differential equations in which a time derivative of the function being sought is not related to a single value of the function being sought, but to a set of values that in turn depend on the value of the function of interest (and optionally also directly on its argument). When differential inclusions are used, the state variables of the equations of movement, which are presented as differential equations, are generalized to sets of possible values.

Accordingly, the results provided are in turn sets of possible locations that can be maximally achieved under the constraints of the model underlying the differential equation. The probabilities with which this happens are irrelevant.

In a further particularly advantageous example embodiment of the present invention, only the objects that have been recognized as a false positive and would be relevant for planning the future behavior of the vehicle or robot if they actually existed are taken into account in ascertaining the performance of the object detection system. As explained above, this ensures that good performance of the object detection system in relation to avoiding false-negative omissions is not unfairly discredited due to such objects that have been recognized as a false positive and would not interfere with the operation of the vehicle or robot. It is thus consciously accepted that false-positive recognitions of objects will occur to a certain extent, so that the object detection system does not develop towards a higher rate of false-negative omissions.

In a further particularly advantageous embodiment of the present invention, the performance of the object detection system is additionally ascertained on the basis of the extent to which objects that are actually present in the surrounding area of the vehicle and/or robot in the situation embodied by the measurement data, as evidenced by prior knowledge, are completely and correctly recognized by the object detection system. Thus, an assessment is made of the extent to which the information present in the situation according to the “ground truth” is correctly evaluated. This optimization objective can be weighted in any way relative to the optimization objective of avoiding certain disturbing false-positive recognitions, for example in the form of a cost function that is a weighted sum of contributions related to the respective optimization objectives.

In a further particularly advantageous embodiment of the present invention, in response to the ascertained performance of the object detection system fulfilling a specified criterion, the architecture of at least one neural network in the object detection system is modified with the objective of improving the performance of the object detection system. For example, it is possible to react if the ascertained performance of the object detection system falls below a specified threshold value or otherwise falls short of expectations. The architecture of the neural network can then be made more complex or deeper, for example, in order to increase processing capacity.

In particular, the architecture of the at least one neural network can be modified, for example, by optimizing at least one hyperparameter that characterizes this architecture with the objective of improving the performance of the object detection system. For example, after each modification to the hyperparameter, the neural network can be retrained, and the impact of this modification on the performance of the object detection system can then be measured.

In a further particularly advantageous example embodiment of the present invention, in response to the ascertained performance of the object detection system fulfilling a specified criterion, at least one neural network in the object detection system is further trained with the objective of improving the performance of the object detection system. For example, if the ascertained performance falls below the threshold value or otherwise falls short of expectations, new training examples can be fed to the neural network in order to close “knowledge gaps” that have led to the poor performance of the object detection system.

These additional training examples can be tailored in particular, for example, to practice better handling of situations in which objects are incorrectly recognized as a false positive in a disruptive manner. Therefore, in particular in further training, measurement data from situations in which more objects that are relevant for planning the future behavior of the vehicle or robot are recognized as a false positive can be overweighted.

If the performance of the object detection system is good, for example, if it exceeds a specified threshold value or otherwise fulfills expectations, the object detection system can be released for productive deployment. In response to the ascertained performance of the object detection system fulfilling a specified criterion, measurement data obtained by observing the surrounding area of the vehicle and/or robot with at least one sensor can be fed to the object detection system. A control signal can then be ascertained using the object instances recognized by the object detection system. The vehicle and/or the robot can then be controlled with the control signal. In this way, the probability is reduced that the vehicle or robot, in response to objects that have been recognized as a false positive, will carry out actions that are not justified by the situation embodied in the measurement data and that, for example, come as a complete surprise to other road users.

This is particularly important in a further especially advantageous embodiment in which a control signal is selected that triggers a braking maneuver and/or an evasive maneuver of the vehicle and/or robot.

The method of the present invention can in particular be wholly or partially computer-implemented. The present invention therefore also relates to a computer program comprising machine-readable instructions that, when executed on one or more computers and/or compute instances, cause the computer(s) and/or compute instance(s) to execute one of the disclosed methods of the present invention. In this sense, control devices for vehicles and embedded systems for technical devices, which are also capable of executing machine-readable instructions, are also to be regarded as computers. Compute instances can, for example, be virtual machines, containers, or serverless execution environments, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for assessing the performance 7 of an object detection system 4, according to the present invention.

FIG. 2 shows an exemplary identification of object instances 5 as objects 5 # that have been recognized as a false positive, according to the present invention.

FIG. 3 shows an exemplary assessment of the performance 7 of an object detection system 4 based on both actually existing object instances 5 and on objects 5 # that have been recognized as a false positive, according to the present invention.

### DETAILED DESCRIPTION OF EXAMPLE EMBODIMENTS

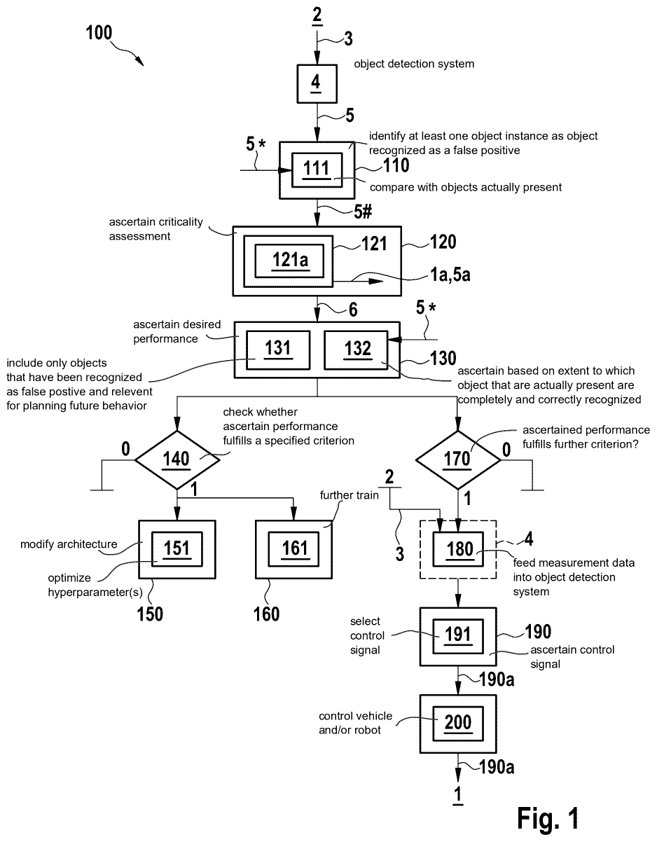

FIG. 1 shows a schematic flow chart of an exemplary embodiment of the method 100 for assessing the performance 7 of an object detection system 4. The object detection system 4 is designed to monitor the surrounding area 2 of a vehicle and/or robot 1 for the presence and/or occurrence of objects on the basis of measurement data 3 that were obtained by observing this surrounding area 2 with at least one sensor.

In step 110, at least one object instance 5 recognized by evaluating the measurement data 3 using the object detection system 4 is identified as an object 5 # that has been recognized as a false positive. An object that has been recognized as a false positive does not correspond to any object actually present in the surrounding area 2 of the vehicle and/or robot 1, i.e. it is not actually present in the surrounding area 2 of the vehicle and/or robot 1.

According to block 111, at least one recognized object instance 5 can be identified as an object 5 # that has been recognized as a false positive by comparing it with objects that are actually present in the surrounding area 2 of the vehicle and/or robot 1 in the situation embodied by the measurement data 3, as evidenced by prior knowledge 5*.

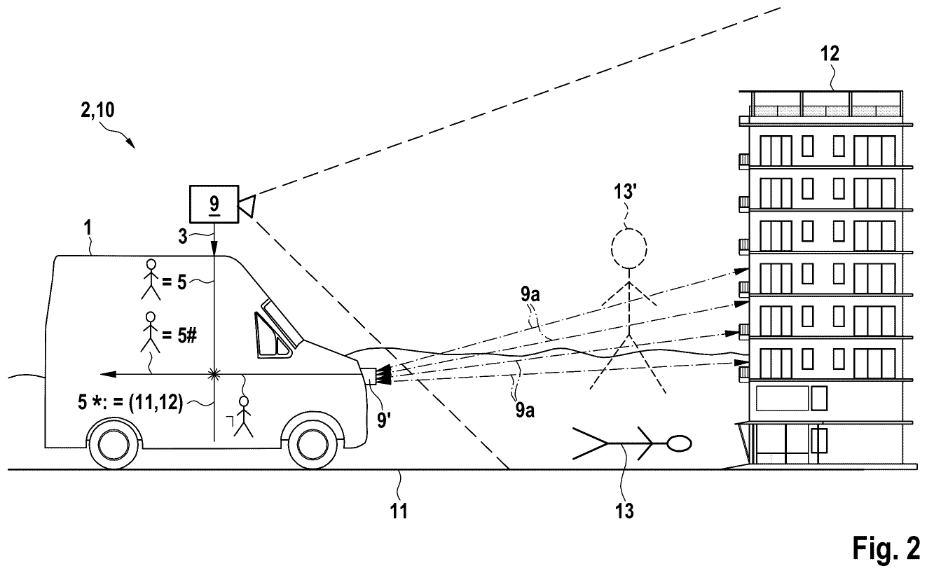

Alternatively or in combination with this, the fusion of measurement data 3 from a plurality of perspectives and/or measurement modalities can be used in order to expose a recognized object instance 5 as an object 5 # that has been recognized as a false positive. This is explained in more detail in connection with FIG. 2.

In step 120, a criticality assessment 6 is ascertained for this object 5 # that has been recognized as a false positive. This criticality assessment 6 is based, at least in part, on the extent to which the object 5 # that has been recognized as a false positive would be relevant for planning the future behavior of the vehicle or robot 1 if it actually existed. The more relevant the object 5 # would be in this case, the more critical its false-positive recognition tends to be.

According to block 121, in response to the fact that the vehicle or robot 1 can reach locations 1a, 5a within a specified forecast horizon that the object 5 # that has been recognized as a false positive could also reach if it actually existed, the object 5 # that has been recognized as a false positive can be assessed as relevant for planning the future behavior of the vehicle or robot 1. For example,
on the one hand, the locations 1a that the vehicle or robot 1 can reach within the forecast horizon, and
on the other hand, the locations 5a that the object 5 # that has been recognized as a false positive could reach if it actually existed
   can be ascertained. If there are overlaps between the set of locations la and the set of locations 5a, the object 5 # that has been recognized as a false positive is relevant for planning the future behavior of the vehicle or robot 1.

In particular, for example, according to block 121a, a type of the object 5 # that has been recognized as a false positive is ascertained by the object detection system 4 and/or by an object classifier downstream of the object detection system 4 and can be used for ascertaining the locations 5a that this object 5 # could reach.

In step 130, the desired performance 7 of the object detection system 4 is ascertained, at least in part, on the basis of criticality assessments 6 of one or more objects 5 # that have been recognized as a false positive.

According to block 131, only the objects 5 # that have been recognized as a false positive and would be relevant for planning the future behavior of the vehicle or robot 1 if they actually existed can be included in ascertaining the performance 7 of the object detection system 4.

According to block 132, the performance 7 of the object detection system 4 can additionally be ascertained on the basis of the extent to which objects that are actually present in the surrounding area 2 of the vehicle and/or robot 1 in the situation embodied by the measurement data 3, as evidenced by prior knowledge 5*, are completely and correctly recognized by the object detection system 4. For example, a cost function can be set up for assessing the performance 7 of both the behavior regarding objects that are actually present and the behavior regarding objects 5 # that have been recognized as a false positive.

In step 140, it can be checked whether the ascertained performance 7 of the object detection system 4 fulfills a specified criterion, for example, whether it falls below a specified threshold value or otherwise falls short of expectations. If this is the case (truth value 1), in step 150, the architecture of at least one neural network in the object detection system 4 can be modified with the objective of improving the performance 7 of the object detection system 4. For this purpose, in particular, for example according to block 151, at least one hyperparameter that characterizes this architecture can be optimized to the objective of improving the performance 7 of the object detection system 4.

Alternatively or in combination therewith, in step 160, at least one neural network in the object detection system 4 can be further trained with the objective of improving the performance 7 of the object detection system 4. For this purpose, in particular, for example, according to block 161, training examples having measurement data 3 from situations in which more objects that are relevant for planning the future behavior of the vehicle or robot 1 are recognized as a false positive can be overweighted.

In step 170, it can be checked whether the ascertained performance 7 of the object detection system 4 fulfills a further criterion, for example, whether it exceeds a specified threshold value or otherwise fulfills specified expectations. If this is the case (truth value 1), the object detection system 4 can be released for productive deployment.

Then, for example, in step 180, measurement data 3 that were obtained by observing the surrounding area 2 of the vehicle and/or robot 1 with at least one sensor can be fed to the object detection system 4. In step 190, a control signal 190a can be ascertained using the object instances 5 recognized by the object detection system 4. The vehicle 1, or the robot 1, can then be controlled with the control signal 190a.

In particular, for example, according to block 191, a control signal 190a can be selected that triggers a braking maneuver and/or an evasive maneuver of the vehicle and/or robot 1. Such maneuvers are particularly disruptive when they are carried out in response to a false-positive recognition of an object 5 #, i.e. without any truly valid reason.

FIG. 2 illustrates two ways in which a recognized object instance 5 can be identified as an object 5 # that has been recognized as a false positive. In the scene 10 shown in FIG. 2, a vehicle 1 has a camera system as the first sensor 9 and a radar sensor as the second sensor 9′ for observing the surrounding area 2 of the vehicle 1. The vehicle 1 is driving on a road 11 leading to a house 12. On the road 11, a pedestrian pictogram 13 is painted to warn drivers that they should pay particular attention to pedestrians. In the situation shown in FIG. 2, the evaluation of the measurement data 3 recorded by the camera system 9 incorrectly recognizes the pedestrian pictogram 13 as a pedestrian 13′ standing on the road.

However, the radar sensor 9′ recognizes that its radar beams 9a pass unobstructed all the way to the house 12 and are reflected from there. This would not be possible if a pedestrian 13′ were actually standing upright in the beam path. Therefore, the combination of the measurement data 3 of the camera system 9 with the measurement data of the radar sensor 9′ provides the information that the recognized upright pedestrian 13′ as object instance 5 is an object 5 # that has been recognized as a false positive.

If prior knowledge 5* is known for the scene 10 in the form of a list of target object instances 5 that are supposed to occur in the scene 10, it can also be specified by comparing it with this list that recognized object instances 5 are objects 5 # that have been recognized as a false positive. In the example shown in FIG. 2, the list comprises only the road 11 and the house 12, but not the upright pedestrian 13′. It is thus clear that the upright pedestrian 13′ is an object 5 # that has been recognized as a false positive.

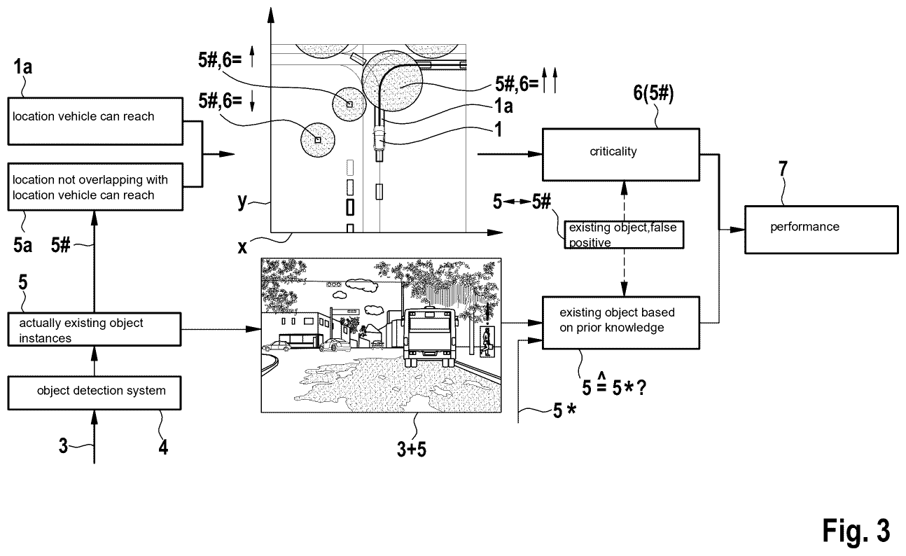

FIG. 3 illustrates how the performance 7 of an object detection system 4 can be assessed both on the basis of actually physically present objects 5 and on the basis of objects 5 # that have been recognized as a false positive.

The object instances 5 recognized by the object recognition system 4 are initially combined with the measurement data 3 present here as an image to form a combination 3+5. In the example shown in FIG. 3, this combination 3+5 is an image with a bounding box superimposed for each recognized object instance 5. Based on prior knowledge 5* about the object instances 5 that are physically present, the extent to which the object instances listed there are recognized completely and correctly can now be checked. For this purpose, for example, an “Intersection over Union” (IoU) can be calculated between the target object instances 5 according to the prior knowledge 5*, on the one hand, and the actually recognized object instances 5, on the other hand. The result can be included as a component in the calculation of the performance 7 of the object recognition system 4.

However, the IoU metric is only applicable for objects for which there is corresponding prior knowledge 5*. There is no such correspondence for objects 5 # that have been recognized as a false positive, so they are not penalized in the IoU metric. Therefore, according to the method proposed here, the objects 5 #that have been recognized as a false positive are identified in a different way. The locations 1a that the vehicle or robot 1 can reach within a specified time forecast horizon are then ascertained. At the same time, the locations 5a that the object 5 # that has been recognized as a false positive could reach within the same forecast horizon, if it could actually exist, are also ascertained.

The locations 1a and 5a are plotted in FIG. 3 in a two-dimensional map that shows a top view of the observed scene in the coordinates x and y.

In the example shown in FIG. 3, for a first object 5 # that has been recognized as a false positive, it is ascertained that the locations 5a that it could reach do not overlap with the locations la that the vehicle 1 can reach. This object 5 # that has been recognized as a false positive is assessed as not relevant for planning the future behavior of the vehicle 1, and is thus as not very critical (criticality 6=↓).

A second object 5 # that has been recognized as a false positive could reach a set of locations 5a that overlaps, at least in the peripheral region, with the locations 1a that can be reached by the vehicle 1. This object 5 # that has been recognized as a false positive is assessed as relevant for the planning of the future behavior of the vehicle 1, and thus as critical (criticality 6=↑).

A third object 5 # that has been recognized as a false positive is a pedestrian whose hypothetically reachable locations 5a largely overlap with the locations 1a that can be reached by the vehicle 1. Thus, this pedestrian would be highly relevant for planning the future behavior of vehicle 1 and is thus assessed as highly critical (criticality 6=↑↑).

In the example shown in FIG. 3, the criticality 6(5 #) of each object 5 # that has been recognized as a false positive is more precisely quantified in the form of a time to collision (TTC). This criticality 6(5 #) is included in the assessment 7 of the performance of the object detection system 4.

1-15. (canceled)

16. A method for assessing performance of an object detection system that monitors a surrounding area of a vehicle and/or robot for presence and/or occurrence of objects based on measurement data obtained by observing the surrounding area with at least one sensor, the method comprising the following steps:
identifying at least one object instance recognized by evaluating the measurement data with the object detection system as an object that has been recognized as a false positive and does not correspond to any object actually present in the surrounding area of the vehicle and/or robot;
ascertaining a criticality assessment for the object recognized as a false positive, which is based, at least in part, on an extent to which the object recognized as a false positive would be relevant for planning a future behavior of the vehicle or robot if the object actually existed;
ascertaining the desired performance of the object detection system, based at least in part on criticality assessments of one or more objects recognized as a false positive.

17. The method according to claim 16, wherein, in response the vehicle or the robot being able to reach locations within a specified forecast horizon that the object that has been recognized as a false positive could also reach if the object actually existed, the object that has been recognized as a false positive is assessed as relevant for planning the future behavior of the vehicle or robot.

18. The method according to claim 17, wherein a type of the object that has been recognized as a false positive is ascertained by the object detection system and/or by an object classifier connected downstream of the object detection system and is used for ascertaining the locations that the object could reach.

19. The method according to claim 17, wherein only those objects that have been recognized as a false positive and would be relevant for planning the future behavior of the vehicle or robot if the objects actually existed are included in ascertaining the performance of the object detection system.

20. The method according to claim 16, wherein the performance of the object detection system is additionally ascertained based on an extent to which objects that are actually present in the surrounding area of the vehicle and/or robot in a situation embodied by the measurement data, as evidenced by prior knowledge, are completely and correctly recognized by the object detection system.

21. The method according to claim 16, wherein, in response to the ascertained performance of the object detection system fulfilling a specified criterion, an architecture of at least one neural network in the object detection system is modified with an objective of improving the performance of the object detection system.

22. The method according to claim 21, wherein the architecture of the at least one neural network is modified by optimizing at least one hyperparameter that characterizes the architecture to the objective of improving the performance of the object detection system.

23. The method according to claim 16, wherein, in response to the ascertained performance of the object detection system fulfilling a specified criterion, at least one neural network in the object detection system is further trained with the objective of improving the performance of the object detection system.

24. The method according to claim 23, wherein in further training, measurement data from situations in which more objects that are relevant for planning the future behavior of the vehicle and/or robot are recognized as a false positive are overweighted.

25. The method according to claim 16, wherein at least one recognized object instance is identified as an object that has been recognized as a false positive by comparing the recognized object instance with objects that are actually present in the surrounding area of the vehicle and/or robot in a situation embodied by the measurement data, as evidenced by prior knowledge.

26. The method according to claim 16, wherein, in response to the ascertained performance fulfilling a specified criterion:
measurement data that were obtained by observing the surrounding area of the vehicle and/or robot with at least one sensor are fed to the object detection system;
using the at least one object instance recognized by the object detection system, a control signal is ascertained; and
the vehicle and/or the robot is controlled with the control signal.

27. The method according to claim 26, wherein a control signal is selected that triggers a braking maneuver of the vehicle and/or robot and/or an evasive maneuver of the vehicle and/or robot.

28. A non-transitory machine-readable data carrier on which is stored a computer program including machine-readable instructions for assessing performance of an object detection system that monitors a surrounding area of a vehicle and/or robot for presence and/or occurrence of objects based on measurement data obtained by observing the surrounding area with at least one sensor, the instructions, when executed by one or more computers and/or computer instances, cause the one or more computers and/or computer instances to perform the following steps:
identifying at least one object instance recognized by evaluating the measurement data with the object detection system as an object that has been recognized as a false positive and does not correspond to any object actually present in the surrounding area of the vehicle and/or robot;
ascertaining a criticality assessment for the object recognized as a false positive, which is based, at least in part, on an extent to which the object recognized as a false positive would be relevant for planning a future behavior of the vehicle or robot if the object actually existed;
ascertaining the desired performance of the object detection system, based at least in part on criticality assessments of one or more objects recognized as a false positive.

29. One or more computers and/or compute instances comprising a non-transitory machine-readable data carrier on which is stored a computer program including machine-readable instructions for assessing performance of an object detection system that monitors a surrounding area of a vehicle and/or robot for presence and/or occurrence of objects based on measurement data obtained by observing the surrounding area with at least one sensor, the instructions, when executed by the one or more computers and/or computer instances, cause the one or more computers and/or computer instances to perform the following steps:
identifying at least one object instance recognized by evaluating the measurement data with the object detection system as an object that has been recognized as a false positive and does not correspond to any object actually present in the surrounding area of the vehicle and/or robot;
ascertaining a criticality assessment for the object recognized as a false positive, which is based, at least in part, on an extent to which the object recognized as a false positive would be relevant for planning a future behavior of the vehicle or robot if the object actually existed;
ascertaining the desired performance of the object detection system, based at least in part on criticality assessments of one or more objects recognized as a false positive.
